(19) United States
(12) Patent Application Publication
(10) Pub. No.: US 2019/0323528 A1
(43) Pub. Date: Oct. 24, 2019

(54) Sensor Device And Method For Checking A Rail Section

(71) Applicant: Siemens Aktiengesellschaft, Munchen (DE)

(72) Inventors: Eik Arnold, München (DE); Jörg Loch, Braunschweig (DE); Cesar Losada Martin, Roseville, CA (US); Matthias Goldammer, München (DE); Sven Gerhard Dudeck, Kirchheim b. München (DE)

(73) Assignee: Siemens Aktiengesellschaft, München (DE)

(21) Appl. No.: 16/387,313

(22) Filed: Apr. 17, 2019

(30) Foreign Application Priority Data
Apr. 18, 2018 (EP) 18168015.8

(51) Int. Cl. F16B 1/00; B61L 23/04

(52) U.S. Cl. CPC F16B 1/00; F16B 2001/0035; B61L 23/042

(57) ABSTRACT

Various embodiments include a sensor device for checking a rail section comprising: a sensor element; and a magnetic fastening element. The magnetic fastening element is configured to attach the sensor element to the rail section.

### CROSS-REFERENCE TO RELATED APPLICATIONS

This application claims priority to EP Application No. 18168015.8 filed Apr. 18, 2018, the contents of which are hereby incorporated by reference in their entirety.

### TECHNICAL FIELD

The present disclosure relates to railroads and/or rails. Various embodiments may include sensor devices and/or methods for checking a rail section, in particular a rail section of a railroad.

### BACKGROUND

Sensors, for example vibration sensors for detecting cracks or breaks, are used in order to monitor rail sections or rails, in particular sections of railroad rails. For this purpose, the sensors are fastened to the rail section by means of a mechanical force-fit connection, for example by means of a clip-type connection, a clamping connection, a bolted fastening or a welded joint. A subsequent change to the spatial position of the sensor is only possible with a great amount of time and effort. This is the case because the mechanical connection between the sensor and the rail section must be sufficiently strong to ensure stable use of the sensor for many years. Conversely, however, it may be necessary to change the spatial position of the sensor, for example in order to improve the signal-to-noise ratio.

Acceleration sensors or optical sensors can be used as sensors. Owing to the relevant frequency range of less than 100 kilohertz, it is also possible to use a flex sensor. In this case the flex sensor is secured by means of mechanical fastening elements so that it is flat against the surface of the rail section to be checked in order to detect a deformation of the rail section. The mechanical fastening elements can in this case disadvantageously affect the measurement, for example through a change to the resonant frequency or a change in the attenuation of a vibration that is to be detected. The signal-to-noise ratio is reduced.

### SUMMARY

The teachings of the present invention describe a sensor device for checking a rail section that has an improved fastening. For example, some embodiments include a sensor device (1) for checking a rail section (2), in particular a rail section of a railroad, comprising a sensor element (4) and at least one magnetic fastening element (41, 42, 43), wherein the sensor device (1) can be attached to the rail section (2) by means of the magnetic fastening element (41, 42, 43).

In some embodiments, said device is embodied as a flex sensor having an elongate sensor element (4).

In some embodiments, the magnetic fastening element (41, 42, 43) is connected to the sensor element (4) by means of a material-to-material bond, in particular an adhesive bond.

In some embodiments, the magnetic fastening element (41, 42, 43) is embodied as a magnetic strip and/or a magnetic film.

In some embodiments, the magnetic fastening element (41, 42, 43) is at least partially embedded in the sensor element (4).

In some embodiments, said device comprises a clamping element by means of which it can additionally be attached mechanically to the rail section (2).

In some embodiments, a buffer element, in particular a foamed material, is arranged between the clamping element and the sensor element.

In some embodiments, said device has a plurality of brackets (6), wherein the sensor device (1) can be attached to the rail section (2) by means of the brackets (6) using a welded joint and/or soldered joint.

In some embodiments, said device comprises at least three magnetic fastening elements (41, 42, 43), wherein one of the magnetic fastening elements (41, 42, 42) is arranged in each of the end regions and one in a center region of the sensor device (1).

In some embodiments, said device comprises a tester element, wherein an electrical voltage can be applied between at least two of the magnetic fastening elements (41, 42, 43) by means of the tester element.

As another example, some embodiments include a method for checking a rail section (2) having a sensor device (1) as described above, said method comprising the steps of: attaching the sensor device (1) to the rail section (2) by means of the at least one magnetic fastening element (41, 42, 43); and capturing at least one measured value by means of the sensor element (4).

In some embodiments, the sensor device (1) is detached from the rail section (2) by means of an induction of eddy currents therein.

### BRIEF DESCRIPTION OF THE DRAWINGS

Further advantages, features, and details of the teachings herein will become apparent from the exemplary embodiments described in the following, as well as with reference to the schematic drawings, in which:

FIG. 1 shows a sensor device incorporating teachings of the present disclosure in a first view;

FIG. 2 shows the sensor device incorporating teachings of the present disclosure in a second view;

FIG. 3 shows a sensor device incorporating teachings of the present disclosure in a first view;

FIG. 4 shows the sensor device incorporating teachings of the present disclosure in a second view; and

FIG. 5 shows a sensor device incorporating teachings of the present disclosure.

Similar, equivalent or like-acting elements may be labeled with the same reference numerals in one of the figures or throughout the figures.

### DETAILED DESCRIPTION

The various embodiments may include a sensor device for checking a rail section, in particular a rail section of a railroad, comprises a sensor element and at least one magnetic fastening element. In some embodiments, the sensor device can be attached to the rail section by means of the magnetic fastening element.

In some embodiments, the fastening element is magnetic and embodied to fasten or fix the sensor device to the rail section. In other words, the magnetic force of the magnetic fastening element is sufficient for securing the sensor device. As a result, the fastening of the sensor device is accomplished electromagnetically and therefore not mechanically. In particular, the magnetic effect of the fastening element can be formed ferromagnetically or electrically. In some embodiments, the magnetic fastening element provides a fastening which is flexible and does not substantially influence the measurement. In some embodiments, as a result of a magnetic connection being formed between the rail section and the sensor device by means of the magnetic fastening element it is possible to detach the sensor device with little effort from the rail section and consequently relocate the same spatially. This enables a flexible adjustment, in particular a readjustment, of the spatial position of the sensor device.

In some embodiments, a method for checking a rail section by means of a sensor device according to the present invention or one of its embodiments comprises at least the following steps:

attaching the sensor device to the rail section by means of the at least one magnetic fastening element; and

capturing at least one measured value by means of the sensor element.

In some embodiments, the sensor device is embodied as a flex sensor having an elongate sensor element. This enables vibrations of the rail section within the relevant frequency range (less than 100 kilohertz) to be measured. The magnetic fastening by means of the magnetic fastening element provided according to the invention does not substantially affect the measurement in this case. The length of the elongate sensor element which is provided and embodied for capturing the measured value or detecting the vibration or flexing of the rail section is in this case in directly correlation to the detectable frequency range or detectable wavelength range. Only vibrations or waves with a half wavelength greater than or equal to the length of the elongate sensor element can be detected with certainty. In other words, the sensor element must span at least one vibration antinode in respect of its length. Vibrations having higher frequencies or smaller wavelengths are mapped into the low-frequency range. Because the sensor element typically has a comparatively small mass, in particular when it is embodied as a flex sensor, a magnetic fastening of the sensor device to the rail section is sufficient to prevent it from being detached from the rail section by vibrations.

In some embodiments, the magnetic fastening element is connected to the sensor element by means of a material-to-material bond, in particular by means of an adhesive bond. In some embodiments, the magnetic fastening element is affixed to the sensor element adhesively. In some embodiments, an adhesive bond is typically electrically nonconducting and elastic.

In some embodiments, the magnetic fastening element is embodied as a magnetic strip and/or a magnetic film. In some embodiments, the magnetic strip or the magnetic film is bonded onto the sensor element with adhesive. In some embodiments, a magnetic strip, such as is also used for whiteboards, is provided for this purpose. A further advantage of the magnetic strip or the magnetic film is their thinness. In some embodiments, this produces an improvement in the signal-to-noise ratio because there is minimum impact on the measurement.

In some embodiments, the magnetic fastening element is at least partially embedded in the sensor element. As a result, the magnetic fastening element may be integrated at least partially into the sensor element. Furthermore, the magnetic fastening element can be molded with the sensor element. The magnetic fastening element can also be arranged on the sensor element or embedded in the latter by means of a vapor phase deposition method.

Basically, the magnetic fastening element can be arranged on the sensor element on the side facing toward or away from the rail section. In other words, the sensor element can also be arranged between the rail section and the magnetic fastening element. This causes the sensor element to be magnetically clamped to the rail section by means of the magnetic fastening element.

In some embodiments, the sensor device comprises at least one clamping element by means of which the sensor device can additionally be attached mechanically to the rail section. In some embodiments, this enables a permanent connection of the sensor device to the rail section. This is of advantage, for example, following a successful adjustment of the sensor device, i.e. after the best possible or a maximally optimal spatial position on the rail section has been determined, possibly after the sensor device has been detached a number of times.

In some embodiments, a buffer element, in particular a foamed material, is arranged between the clamping element and the sensor element. In some embodiments, the contact between the clamping element and the sensor element may be embodied as soft or elastic. In some embodiments, the buffer element, in particular the foamed material, is only in the region of the magnetic fastening element. In some embodiments, no force is applied to the sensor element, in particular in a deflection direction of the latter. The sensor device is nevertheless adequately fixed mechanically to the rail section by means of the clamping element. In some embodiments, a previous adjustment of the sensor device is not negatively modified due to the buffer element.

In some embodiments, a housing can be provided which protects in particular the sensor element and/or the magnetic fastening element against environmental influences.

In some embodiments, the sensor device has a plurality of brackets, the sensor device being attachable to the rail section by means of the brackets using a welded joint and/or soldered joint. In some embodiments, the brackets are in this case arranged adjacent to the magnetic fastening element or the magnetic fastening elements. In some embodiments, brackets can be placed over the sensor device to achieve a mechanical or material-to-material connection between the sensor device and the rail section.

In some embodiments, the sensor device comprises at least three, in particular precisely three, magnetic fastening elements, where one of the magnetic fastening elements is arranged in each of the end regions and one in a center region of the sensor device. In other words, one of the three fastening elements is arranged at either end of the sensor element. Another of the three fastening elements is arranged in the middle of the sensor element. This results in an embodiment in the form of a magnetic three-point fastening. A magnetic N-point fastening can be provided, where N is equal to two or greater than three. This advantageously further reduces the effect of the magnetic fastening on the measurement. Typically, a three-point fastening is sufficient on account of the embodiment whereby the length of the sensor element is less than or equal to the half wavelength of the vibration.

In some embodiments, the sensor device comprises a tester element, it being possible to apply an electrical voltage between at least two of the magnetic fastening elements by means of the tester element. In some embodiments, this enables the connection between the sensor device and the rail section to be checked. In particular, contaminants that may be present between the rail section and the magnetic fastening elements and that could lead to a reduction of the holding force of the magnetic fastening elements can be detected thereby. This prevents the sensor device being detached from the rail section prematurely. In this situation a contamination can be detected based on an increased electrical resistance between the magnetic fastening elements.

In some embodiments, the sensor device is detached from the rail section by means of an induction of eddy currents therein. In some embodiments, this enables the sensor device to be detached in a reliable and efficient manner. This is of advantage in particular for allowing an adjustment of the sensor device or a calibration in respect of its spatial position.

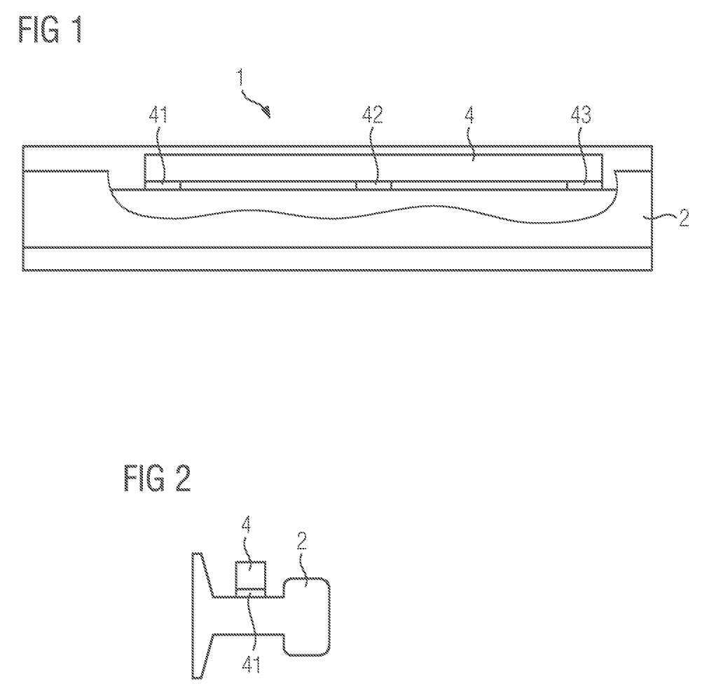

FIG. 1 shows a sensor device 1 incorporating teachings of the present disclosure in a first view. The sensor device 1 comprises an elongate sensor element 4 as well as three magnetic fastening elements 41, 42, 43. The sensor device 1 is arranged on or attached to a rail section 2, i.e. a portion of a rail, in particular a rail of a railroad track, by means of the three magnetic fastening elements 41, 42, 43. The sensor element 4 is embodied as elongate, meaning that it has an aspect ratio (length/width) of greater than one, in particular greater than five.

One of the magnetic fastening elements 41, 42, 43 is arranged at one end of the sensor element 4. Another of the magnetic fastening elements 41, 42, 43 is arranged at the other end of the sensor element 4. The magnetic fastening element 42 is arranged in the center of the sensor element 4. The magnetic fastening elements 41, 42, 43 may comprise magnetic strips. In some embodiments, the magnetic fastening elements 41, 42, 43 have a dimension extending along the length of the sensor element 4 which is smaller, in or substantially smaller, than the length of the sensor element 4. In some embodiments, a three-point connection between the sensor element 4 and the rail section 2 is made possible as a result. In some embodiments, the magnetic fastening elements 41, 42, 43 extend across the entire width of the sensor element 4.

In the embodiment shown, the magnetic fastening elements 41, 42, face toward the rail section 2. In some embodiments, the magnetic fastening elements 41, 42, 43 face away from the rail section 2 and consequently are able to clamp the sensor element 4 in place.

FIG. 2 shows the sensor device 1 illustrated in FIG. 1 in a second view. FIG. 2 has the same elements as already shown in FIG. 1. The profile of the rail section 2 is recognizable from FIG. 2. The sensor device 1 is arranged on a connecting web of the rail section 2 between a rail foot and a rail head of the rail section 2.

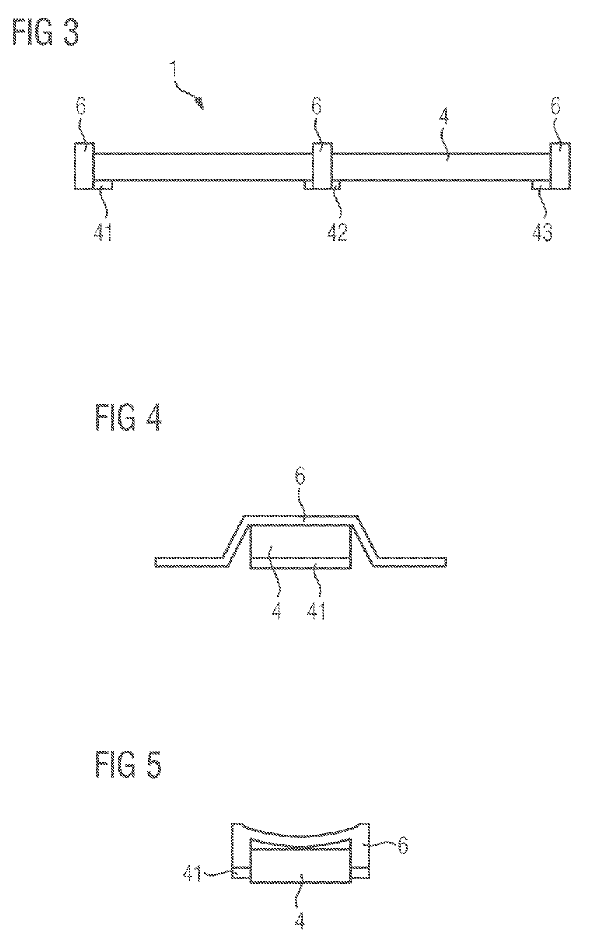

FIG. 3 shows a sensor device 1 incorporating teachings of the present disclosure in a first view. In this variant the sensor device 1 has the same elements as the sensor device already illustrated in FIG. 1. Accordingly, the statements made with reference to FIG. 1 can be applied directly and explicitly to the sensor device 1 of FIG. 2.

In addition to the sensor device of FIG. 1, the sensor device 1 shown in FIG. 2 has three brackets 6. The brackets 6 provide an additional mechanical connection to the rail section 2. The brackets 6 are arranged adjacently next to the magnetic fastening elements 41, 42, 43. In this variant the brackets 6 are able to press the sensor device 1 or the sensor element 4 against the rail section 2 and fix it in position in a force-fit manner. The brackets 6 can be fastened to the rail section 2 by means of a welded joint and/or soldered joint. A bolted fastening can also be provided.

FIG. 4 shows the sensor device 1 illustrated in FIG. 3 in a second view. FIG. 4 has the same elements as shown already in FIG. 3. As can be seen from FIG. 4, the brackets 6 extend over the sensor element 4 and the magnetic fastening elements 41, 42, 43. In this case the brackets 6 are embodied in a concave shape.

FIG. 5 shows a sensor device 1 incorporating teachings of the present disclosure. The illustrated sensor device 1 substantially corresponds to the sensor device shown in FIGS. 3 and 5, though with an alternative embodiment of the brackets 6. In this case the brackets 6 are substantially convex. This enables or causes the sensor element 4 to be pressed against the rail section (not shown here) by means of a spring action of the brackets 6.

Although the teachings herein have been illustrated and described in more detail on the basis of the exemplary embodiments, the scope is not limited by the disclosed examples and other variations may be derived herefrom by the person skilled in the art without leaving the scope of the teachings herein.

### LIST OF REFERENCE NUMERALS

1 Sensor device

2 Rail section

4 Sensor element

6 Bracket

41 First magnetic fastening element

42 Second magnetic fastening element

43 Third magnetic fastening element

1. A sensor device for checking a rail section, the sensor device comprising:
a sensor element; and
a magnetic fastening element;
wherein the magnetic fastening element is configured to attach the sensor element to the rail section.

2. The sensor device as claimed in claim 1, wherein the sensor element comprises an elongated flex sensor.

3. The sensor device as claimed in claim 1, wherein the magnetic fastening element is connected to the sensor element with a material-to-material bond.

4. The sensor device as claimed in claim 1, wherein the magnetic fastening element comprises a magnetic strip or a magnetic film.

5. The sensor device as claimed in claim 1, wherein the magnetic fastening element is at least partially embedded in the sensor element.

6. The sensor device as claimed in claim 1, further comprising a clamping element to form a mechanical attachment to the rail section.

7. The sensor device as claimed in claim 6, further comprising a buffer element arranged between the clamping element and the sensor element.

8. The sensor device as claimed in claim 1, further comprising a plurality of brackets;
wherein the plurality of brackets is configured to attach the sensor element to the rail section using a welded joint or soldered joint.

9. The sensor device as claimed in claim 1, further comprising at least two additional magnetic fastening elements;
wherein a respective magnetic fastening element is arranged in each end region of the sensor device and one is arranged in a center region of the sensor device.

10. The sensor device as claimed in claim 9, further comprising a tester element configured to apply an electrical voltage between at least two of the magnetic fastening elements.

11. A method for checking a rail section, the method comprising:
attaching a sensor device to the rail section, the sensor device comprising a sensor element and a magnetic fastening element, using the magnetic fastening element; and
capturing a measured value with the sensor element.

12. The method as claimed in claim 11, further comprising detaching the sensor device from the rail section using an induction of eddy currents therein.
